(19) United States
(12) Patent Application Publication
(10) Pub. No.: US 2020/0282722 A1
(43) Pub. Date: Sep. 10, 2020

(54) INKJET RECORDING DEVICE AND MAINTENANCE METHOD

(71) Applicant: Konica Minolta, Inc., Tokyo (JP)

(72) Inventor: Hiroyuki TOKIMATSU, Tokyo (JP)

(21) Appl. No.: 16/796,683

(22) Filed: Feb. 20, 2020

(30) Foreign Application Priority Data
Mar. 8, 2019 (JP) 2019-043001

(51) Int. Cl. B41J 2/05; B41J 2/045; B41J 2/03; B41J 2/165

(52) U.S. Cl. CPC B41J 2/05; B41J 2/16538; B41J 2/03; B41J 2/04563

(57) ABSTRACT

Provided is an inkjet recording device including: an inkjet head; an ink storage; a flow passage; a negative pressure generator; a heater; a wiper; and a hardware processor, in which in a case in which the ink inside the ink filled region is a solid, the hardware processor performs heating control including control of generating a negative pressure in the ink storage, and control of heating the ink in the ink filled region in a state in which the negative pressure is generated to change the phase of the ink from a solid to a liquid, and in a case in which the negative pressure in the ink storage acts on the ink in the nozzle by the heating control, the hardware processor initiates wiping control of performing the wiping operation and performs the wiping control in combination with the heating control.

### CROSS-REFERENCE TO RELATED APPLICATIONS

The entire disclosure of Japanese Patent Application No. 2019-043001 filed on Mar. 8, 2019 is incorporated herein by reference in its entirety.

### BACKGROUND

### Technological Field

The present invention relates to an inkjet recording device and a maintenance method.

### Description of the Related Art

In the related art, there is disclosed an inkjet recording device that records an image on a recording medium by ejecting ink to the recording medium from a nozzle provided in an inkjet head. In the inkjet recording device, ink in an ink storage is supplied to the inkjet head through a flow passage, and is ejected from the nozzle. In addition, there is disclosed a technology in which a negative pressure is caused to occur in the ink storage, and the negative pressure is caused to act on the ink in the nozzle through ink in an ink filled region that leads to the nozzle of the inkjet head from the ink storage to suppress leakage of ink from the nozzle in ink non-ejection.

With regard to the ink that can be used in the inkjet recording device, there is phase change ink having characteristics in which the ink becomes a liquid from a solid when being heated to a temperature that is equal to or higher than a predetermined phase change temperature (for example, approximately 50° C. to 70° C.) (for example, JP 2012-121287 A). The inkjet recording device that uses the phase change ink is provided with a heater that heats ink in the ink filled region and ejects heated liquid ink from the nozzle.

In addition, in the related art, there is disclosed a technology of suppressing image quality deterioration due to defective ink ejection from a nozzle by performing a subsequent image recording operation after performing a predetermined maintenance operation relating to ink ejection in a case in which the inkjet recording device is activated.

### SUMMARY

However, when activating the inkjet recording device, in a case in which ink in the ink filled region becomes a solid, if the maintenance operation is performed after heating the ink to liquefy the entirety of the ink, there is a problem that a standby time until the maintenance operation is terminated and an image recording operation is initiated becomes longer.

An object of the invention is to provide an inkjet recording device and a maintenance method which are capable of shortening standby time in activation.

To achieve at least one of the abovementioned objects, according to an aspect of the present invention, an inkjet recording device reflecting one aspect of the present invention includes:

an inkjet head that includes a nozzle from which ink of which a phase is changed between a solid and a liquid is ejected;

an ink storage that stores the ink;

a flow passage which is connected to the ink storage and the inkjet head and through which the ink to be supplied from the ink storage to the inkjet head passes;

a negative pressure generator that generates a negative pressure in the ink storage;

a heater that heats ink in an ink filled region in the ink storage, the flow passage, and the inkjet head;

a wiper that performs a wiping operation of wiping a nozzle opening surface of the inkjet head in which an opening portion of the nozzle is formed with a wiping member, and

a hardware processor,

in which in a case in which the ink inside the ink filled region is a solid, the hardware processor performs heating control including control of causing the negative pressure generator to generate a negative pressure in the ink storage, and control of causing the heater to heat the ink in the ink filled region in a state in which the negative pressure is generated to change the phase of the ink from a solid to a liquid, and

in a case in which the negative pressure in the ink storage acts on the ink in the nozzle by the heating control, the hardware processor initiates wiping control of causing the wiper to perform the wiping operation and performs the wiping control in combination with the heating control.

To achieve at least one of the abovementioned objects, according to an aspect of the present invention, a maintenance method reflecting one aspect of the present invention of an inkjet recording device including an inkjet head that includes a nozzle from which ink of which a phase is changed between a solid and a liquid is ejected, an ink storage that stores the ink, a flow passage which is connected to the ink storage and the inkjet head and through which the ink to be supplied from the ink storage to the inkjet head passes, a negative pressure generator that generates a negative pressure in the ink storage, a heater that heats ink in an ink filled region in the ink storage, the flow passage, and the inkjet head, and a wiper that performs a wiping operation of wiping a nozzle opening surface of the inkjet head in which an opening portion of the nozzle is formed with a wiping member, the maintenance method comprises:

generating a negative pressure in the ink storage by the negative pressure generator, and changing the phase of the ink from a solid to a liquid by heating the ink in the ink filled region by the heater in a state in which the negative pressure is generated in a case in which the ink inside the ink filled region is a solid;

initiating the wiping operation by the wiper in a case in which the negative pressure in the ink storage acts on the ink in the nozzle; and

causing the wiping operation to be performed while changing the phase of the ink from a solid to a liquid.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a view illustrating a schematic configuration of an inkjet recording device;

FIG. 2 is a schematic view illustrating a configuration of a head unit;

FIG. 3 is a view illustrating a state in which a head unit is caused to move in a width direction;

FIG. 4 is a view illustrating a movable position of the head unit in the width direction;

FIG. 5 is a view illustrating a configuration of a cleaner;

FIG. 6 shows an example of a variation of ink viscosity corresponding to ink temperature rising and lowering;

FIG. 7 is a view for describing a configuration of an ink flow path in the head unit;

FIG. 8 is a cross-sectional view of an ink flow passage in a second sub-tank, a second flow passage, and an inkjet head;

FIG. 9 is a block diagram illustrating a functional configuration of the inkjet recording device;

FIG. 10A is a view illustrating a state in which gel-phase ink is heated and becomes sol-phase ink;

FIG. 10B is a view illustrating a state in which gel-phase ink is heated and becomes sol-phase ink;

FIG. 10C is a view illustrating a state in which gel-phase ink is heated and becomes sol-phase ink;

FIG. 10D is a view illustrating a state in which gel-phase ink is heated and becomes sol-phase ink;

FIG. 11 is a view showing a temperature variation of ink near an inner wall surface and ink at the center in ink heating;

FIG. 12 is a view illustrating an execution procedure and execution timing of each operation in a maintenance operation in activation in the related art and in the maintenance operation in activation in this embodiment;

FIG. 13 is a cross-sectional view of an ink flow passage in a second sub-tank, a second flow passage, and an inkjet head in a state in which ink inside a head chip enters a sol state;

FIG. 14 is a view illustrating a state in which ink on a wall surface of each portion of an ink filled region becomes sol-phase ink; and

FIG. 15 is a flowchart illustrating a control sequence of maintenance processing in activation.

### DETAILED DESCRIPTION OF THE EMBODIMENTS

Hereinafter, an embodiment according to an inkjet recording device and a maintenance method of the invention will be described with reference to the accompanying drawings. However, the scope of the invention is not limited to the disclosed embodiments.

(Configuration of Inkjet Recording Device)

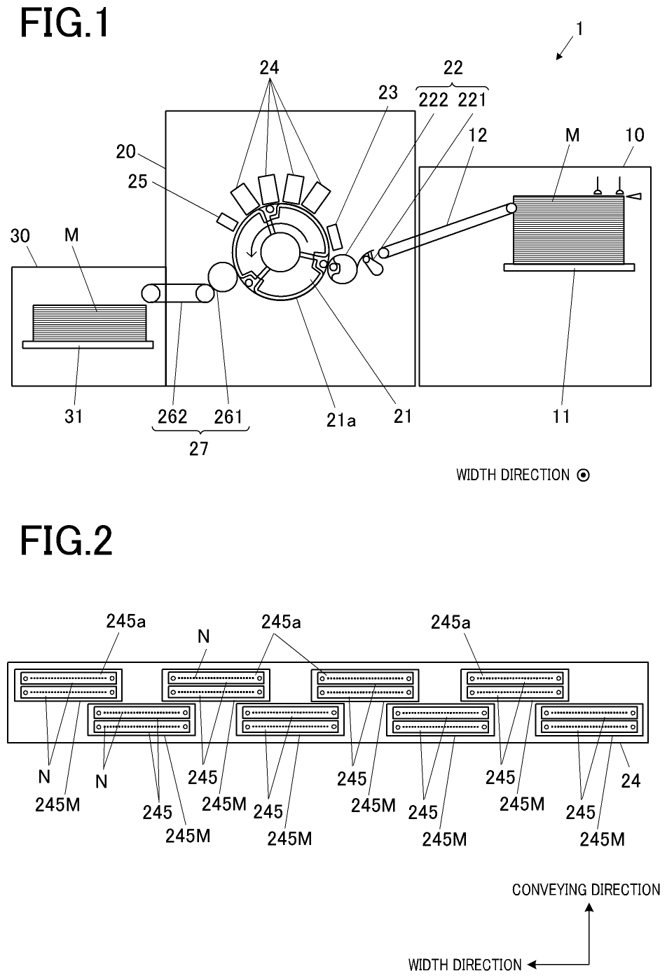

FIG. 1 is a view illustrating a schematic configuration of an inkjet recording device 1 as an embodiment of the invention.

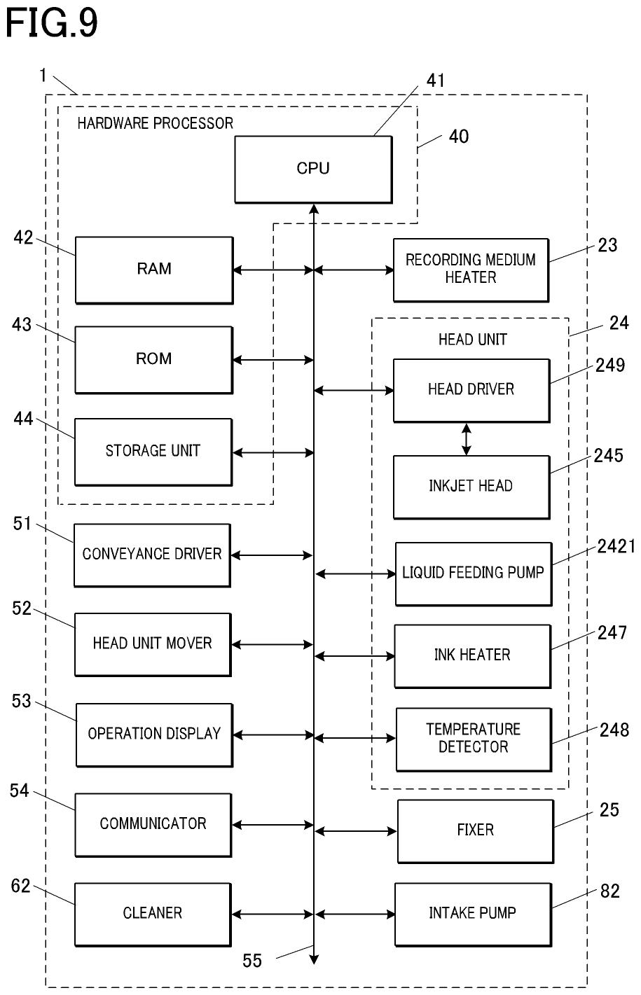

The inkjet recording device 1 includes a paper feeder 10, an image former 20, a paper ejector 30, and a controller 40 (a hardware processor) (FIG. 9). The inkjet recording device 1 conveys a recording medium M accommodated in the paper feeder 10 to the image former 20 under control by the hardware processor 40, records an image on the recording medium M with the image former 20, and conveys the recording medium M on which the image is recorded to the paper ejector 30. As the recording medium M, in addition to paper such as plain paper and coated paper, various media such as cloth and a sheet-shaped resin onto which ink that has landed on the surface can be fixed can be used.

The paper feeder 10 includes a paper feeding tray 11 on which the recording medium M is stored, and a medium feeder 12 that conveys and feeds the recording medium M from the paper feeding tray 11 to the image former 20. The medium feeder 12 includes a ring-shaped belt of which an inner side is supported by two rollers, and conveys the recording medium M from the paper feeding tray 11 to the image former 20 by rotating the rollers in a state in which the recording medium M is placed on the belt.

The image former 20 includes a conveying drum 21 (conveyor), a conveying unit 22, a recording medium heater 23, a head unit 24, a fixer 25, a deliverer 26, and the like.

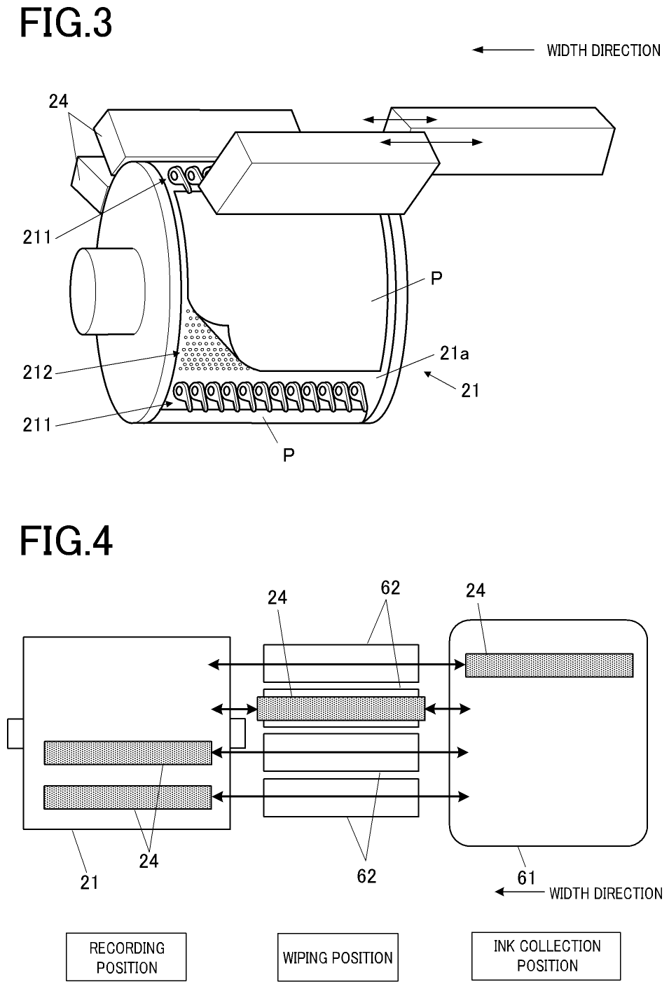

The conveying drum 21 rotates around a rotation axis extending to a direction (hereinafter, referred to as a width direction) orthogonal to the drawing in FIG. 1 in a state of carrying the recording medium M on a conveying surface 21a that is a cylindrical surface-shaped outer peripheral surface to convey the recording medium M in a conveying direction along the conveying surface 21a. The conveying drum 21 includes a claw 211 (refer to FIG. 3) and an intake 212 (refer to FIG. 3) configured to hold the recording medium M on the conveying surface 21a. An end portion of the recording medium M is pressed by the claw 211, and the conveying surface 21a is suctioned by the intake 212. According to this, the recording medium M is held on the conveying surface 21a.

The conveying drum 21 is connected to a conveying drum motor (not illustrated) for rotating the conveying drum 21, and rotates by an angle proportional to a rotation amount of the conveying motor drum.

The conveying unit 22 guides the recording medium M conveyed by the medium feeder 12 of the paper feeder 10 to the conveying drum 21. The conveying unit 22 is provided at a position between the medium feeder 12 of the paper feeder 10 and the conveying drum 21, and holds one end of the recording medium M conveyed from the medium feeder 12 with a swing arm 221 and guides the recording medium M to the conveying drum 21 through a conveying drum 222.

The recording medium heater 23 is provided between an arrangement position of the conveying drum 222 and an arrangement position of the head unit 24, and heats the recording medium M so that the recording medium M conveyed by the conveying drum 21 reaches a temperature within a predetermined temperature range. For example, the recording medium heater 23 includes an infrared heater or the like, and energizes the infrared heat on the basis of a control signal supplied from the hardware processor 40 to cause the heater to generate heat.

The head unit 24 records an image by performing a recording operation of ejecting ink to the recording medium M from an ink ejection surface (a nozzle opening surface 245a of an inkjet head 245 to be described later) (refer to FIG. 2) that faces the conveying surface 21a of the conveying drum 21 at appropriate timing corresponding to rotation of the conveying drum 21 on which the recording medium M is carried. The head unit 24 is disposed so that the nozzle opening surface 245a and the conveying surface are spaced apart from each other by a predetermined distance. In the inkjet recording device 1 of this embodiment, four head units 24 which respectively corresponding to four colors of ink of yellow (Y), magenta (M), cyan (C), and black (K) are arranged to be aligned in the order of colors of Y, M, C, and K from an upstream side in a conveying direction of the recording medium M with predetermined intervals.

FIG. 2 is a schematic view illustrating a configuration of the head unit 24. FIG. 2 is a plan view when the entirety of the head unit 24 is seen from a side opposite to the conveying surface 21a of the conveying drum 21.

In this embodiment, the head unit 24 includes sixteen inkjet heads 245 in which a plurality of recording elements which eject ink are arranged in a width direction. The recording elements of the inkjet head 245 includes a pressure chamber that stores ink, a piezoelectric element provided on a wall surface of the pressure chamber, and a nozzle N. In the recording element, in a case in which a drive signal for deforming the piezoelectric element is input, the pressure chamber is deformed due to deformation of the piezoelectric element and a pressure inside the pressure changer varies, and an ink ejection operation of ejecting ink from the nozzle N that communicates with the pressure chamber is performed.

In FIG. 2, a position of an opening portion of the nozzle N in the nozzle opening surface 245a of each of the inkjet heads 245. An arrangement direction of the recording elements in the inkjet heads 245 is not limited to the width direction orthogonal to the conveying direction, and may be a direction intersecting the conveying direction at an angle other than a right angle.

In the head unit 24, a head module 245M is constituted by two pieces of the inkjet heads 245 arranged to be adjacent to each other in the conveying direction at a positional relationship in which the nozzles N of the recording elements are alternately disposed with respect to the width direction. In addition, eight pieces of the head modules 245M are arranged in a staggered pattern so that arrangement ranges relating to the width direction partially overlap each other at a positional relationship in which ranges capable of ejecting ink from the nozzle N are continuously connected in the width direction. According to this, a line head is constituted.

The arrangement ranges relating to the width direction of the nozzles N included in the head unit 24 covers a width in the width direction of a region of the recording medium M, which is conveyed by the conveying drum 21, in which an image can be recorded. The head unit 24 is used in a state in which a position thereof is fixed at the time of recording an image, and sequentially ejects ink to different positions in the conveying direction at a predetermined interval (conveying direction interval) in correspondence with conveyance of the recording medium M, thereby recording an image in a single path type.

The head unit 24 is provided to be individually movable along the width direction.

FIG. 3 is a view illustrating a state in which the head unit 24 is moved in the width direction.

In addition. FIG. 4 is a view illustrating a movable position of the head unit 24 in the width direction.

The head unit 24 is driven by a head unit mover 52 (refer to FIG. 9) to move in the width direction between a recording position, a wiping position (second position), and an ink collection position (first position) as illustrated in FIG. 3 and FIG. 4.

Among the positions, the recording position is a position at which the nozzle opening surface 245a of the inkjet head 245 (an ink ejection surface of the head unit 24) corresponds to the conveying surface 21a of the conveying drum 21, and a position in a case in which ink is ejected to the recording medium M on the conveying surface 21a to record an image.

In addition, the wiping position is a position to which the head unit 24 is moved in a case in which the nozzle opening surface 245a of the inkjet head 245 is cleaned. At the wiping position, the nozzle opening surface 245a of the inkjet head 245 faces a cleaner 62 (wiper).

In addition, the ink collection position is a position to which the head unit 24 is moved in a case in which ink that leaks and drops from the nozzle N of the inkjet head 245 or ink that is ejected therefrom is collected by an ink collector 61. At the ink collection position, the ink collector 61 that receives the ink that is ejected or leaks from the nozzle N is disposed on a lower side of the nozzle opening surface 245a of the inkjet head 245. In FIG. 4, the ink collector 61 that is common to four pieces of the head units 24 is provided, but in a case in which respective colors of ink are individually collected, the ink collector may be formed for every head unit 24.

FIG. 5 is a view illustrating a configuration of the cleaner 62.

The cleaner 62 wipes the nozzle opening surface 245a of the inkjet head 245 with wiping fabric 621 (wiping member), and remove ink foreign matters, ink, and the like which are attached to the nozzle opening surface 245a for cleaning.

The cleaner 62 includes a replaceable wiping fabric 621 that wipes the nozzle opening surface 245a, and an elastic member 622 that comes into contact with or is spaced apart from the nozzle opening surface 245a through the wiping fabric 621. The wiping fabric 621 is a long sheet member, and for example, nonwoven fabric or the like can be used as the wiping fabric 621. In addition, the wiping fabric 621 is unwound from an unwinding roller 623, wipes the nozzle opening surface 245a, and is wound by a winding roller 624. In addition, the wiping fabric 621 moves in an upper and lower direction in combination with the elastic member 622 in a case in which the elastic member 622 comes into contact with or is spaced apart from the nozzle opening surface 245a of the inkjet head 245. The nozzle opening surface 245a is wiped by the wiping fabric 621 by winding and moving the wiping fabric 621 by the winding roller 624 while causing the wiping fabric 621 to come into contact with the nozzle opening surface 245a by the elastic member 622.

Ink that is used in image recording by the head unit 24 has a phase change property between a gel phase and a sol phase in accordance with a temperature. The gel phase is one aspect of a solid, and the sol phase is one aspect of a liquid. Examples of a combination of the ink include ink obtained by adding several % of gelling agent to a composition manly including a polymerizable compound and a photopolymerization initiator.

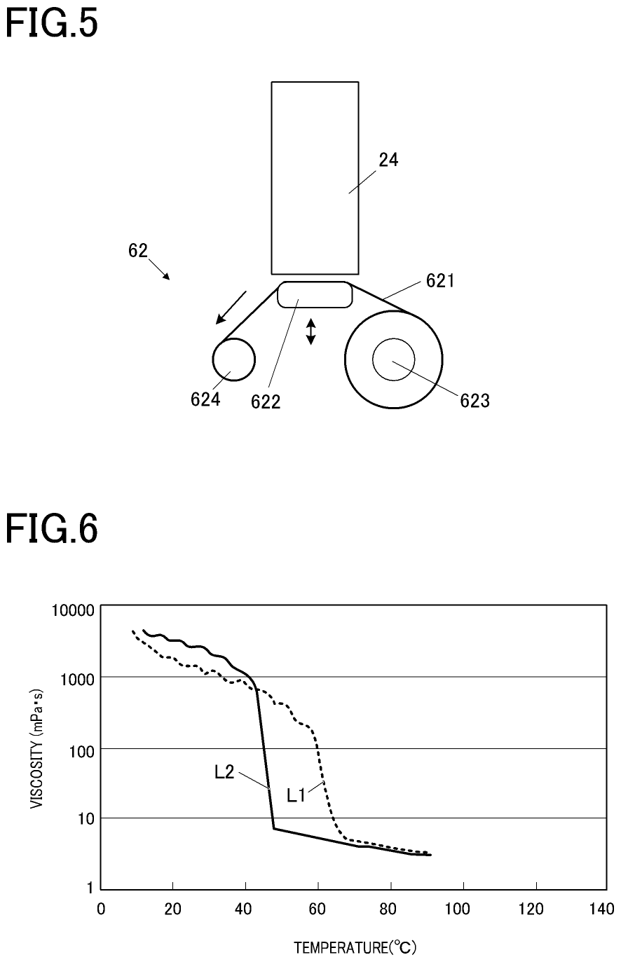

FIG. 6 shows an example of a variation of ink viscosity corresponding temperature rising and lowering of the ink.

In FIG. 6, a line L1 represents a variation example of the ink viscosity in temperature rising, and a line L2 represents a variation example of the ink viscosity in temperature lowering.

As indicated by the line L1 in FIG. 6, as gel-phase ink is heated and a temperature thereof is raised, the viscosity remarkably decreases at approximately 70° C., and phase change into a sol phase occurs. Hereinafter, a temperature at which the phase of the gel-phase ink is changed to the sol phase is described as a liquefaction temperature.

On the other hand, as indicated by the line L2 in FIG. 3, as the temperature of the sol-phase ink is lowered, the viscosity significantly rises at approximately 50° C., and phase change into a gel phase occurs. Hereinafter, a temperature at which the phase of the sol-phase ink is changed to the gel phase is described as a gelation temperature.

The head unit 24 includes an ink heater 247 (heater) that heats the ink having the above-described characteristic to the liquefaction temperature or higher to make the ink be the sol phase on an inner side (refer to FIG. 9). The head unit 24 ejects the ink that is heated by the ink heater 247 to the sol phase from the nozzle N. As shown in FIG. 6, viscosity of ink heated to the liquefaction temperature or higher also varies in accordance with a temperature, and thus the ink inside the head unit 24 is controlled to a predetermined temperature range that is higher than the liquefaction temperature. For example, the temperature range can be set to a temperature (75° C. or higher) equal to or higher than the ink liquefaction temperature (here, 70° C.) by +5° C. or higher and a temperature (90° C. or lower) equal to or lower than the ink liquefaction temperature by +15° C. or less.

In the head unit 24 of this embodiment, the ink heater 247 is configured to constantly maintain the ink temperature to 80° C. under control by the hardware processor 40. Hereinafter, a control target value of the ink temperature is also described as “reference temperature”.

In addition, ink that is used in this embodiment has a property of being cured by irradiation with ultraviolet rays. That is in the inkjet recording device 1 of this embodiment, sol-phase ink is ejected to the recording medium M placed on the conveying surface 21a, is cooled down on the recording medium M to a gel phase, and is cured by irradiation with ultraviolet rays. According to this, it is possible to fix the ink onto the recording medium M.

The fixer 25 illustrated in FIG. 1 includes an ultraviolet irradiator that is disposed over a width of the conveying drum 21 in the width direction, and the recording medium M placed on the conveying drum 21 is irradiated with ultraviolet rays from the ultraviolet irradiator to cure and fix the ink that is ejected onto the recording medium M. The ultraviolet irradiator of the fixer 25 is disposed to face the conveying surface between an arrangement position of the head unit 24 and an arrangement position of the conveying drum 261 of the deliverer 26 in the conveying direction.

The deliverer 26 includes a belt loop 262 including a ring-shaped belt of which an inner side is supported by two rollers, and the cylindrical conveying drum 261 that conveys the recording medium M from the conveying drum 21 to the belt loop 262, and the recording medium M conveyed from the conveying drum 21 onto the belt loop 262 by the conveying drum 261 is conveyed by the belt loop 262 and is transmitted to the paper ejector 30.

The paper ejector 30 includes a plate-shaped paper ejection tray 31 on which the recording medium M transferred from the image former 20 by the deliverer 26 is placed.

Next, a configuration relating to an ink flow path in the lead unit 24 will be described.

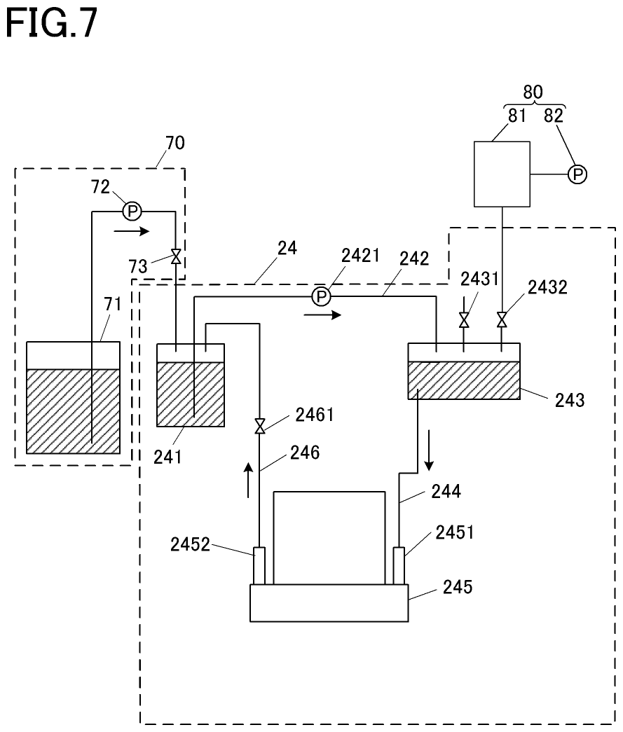

FIG. 7 is a view for describing a configuration relating to the ink flow path in the head unit 24.

In FIG. 7, one piece of the head unit 24, an ink supplier 70 and a negative pressure generator 80 which are connected to the head unit 24 are illustrated.

The ink supplier 70 stores ink having a predetermined color (color corresponding to the head unit 24) that is used in image recording and supplies the ink to the head unit 24. The ink supplier 70 includes a main tank 71, a supply pump 72, a supply valve 73, and the like.

Ink in the main tank 71 is transmitted to a first sub-tank 241 in the head unit 24 through the supply valve 73 through an operation of the supply pump 72. The supply valve 73 determines ink supply possibility from the main tank 71 to the first sub-tank 241. The supply valve 73 may be set as an electromagnetic valve that is opened and closed on the basis of a control operation of the hardware processor 40.

The head unit 24 includes the first sub-tank 241, a first flow passage 242, a liquid feeding pump 2421, a second sub-tank 243 (ink storage), a second flow passage 244 (flow passage), an inkjet head 245, a third flow passage 246, and the like. The tanks and the flow passages are provided with the ink heater 247 that heats inner ink into the sol phase, but description thereof is omitted in FIG. 7. For example, the ink heater 247 can be set as a rubber heater attached to an outer wall surface of each of the tanks and the flow passages, but there is no limitation thereto as long as the tanks and the flow passages can be heated.

The first sub-tank 241 is an ink tank having capacity less than that of the main tank 71, and stores ink supplied from the main tank 71. In addition, ink that is circulated from an outlet 2452 of the inkjet head 245 through the third flow passage 246 is stored in the first sub-tank 241.

The liquid feeding pump 2421 is provided in the first flow passage 242, and feeds ink from the first sub-tank 241 to the second sub-tank 243 through the first flow passage 242. As the liquid feeding pump 2421, a pump that is known in the related art can be used. In addition, in a case in which the second sub-tank 243 does not communicate with the air or an air tank 81, ink pressurized by a liquid feeding operation of the liquid feeding pump 2421 is supplied to the inkjet head 245 through the second sub-tank 243.

The second sub-tank 243 stores ink transmitted from the first sub-tank 241. The second sub-tank 243 communicates with the air by opening an air open valve 2431, and communicates with the air tank 81 by opening an air open valve 2432. In a case in which the air open valve 2432 is opened, an ink pressure is adjusted so that ink is not leaked from a nozzle in a typical case due to a pressure difference with an ink pressure in the nozzle opening surface 245a of the inkjet head 245 due to an air pressure (negative pressure) inside the air tank 81, and in a case in which the pressure difference varies due to ink ejection or the like, ink corresponding to the pressure difference is supplied to the inkjet head 245. The pressure inside the air tank 81 is set to a negative pressure when being suctioned by an intake pump 82. The air tank 81 and the intake pump 82 constitute a negative pressure generator 80.

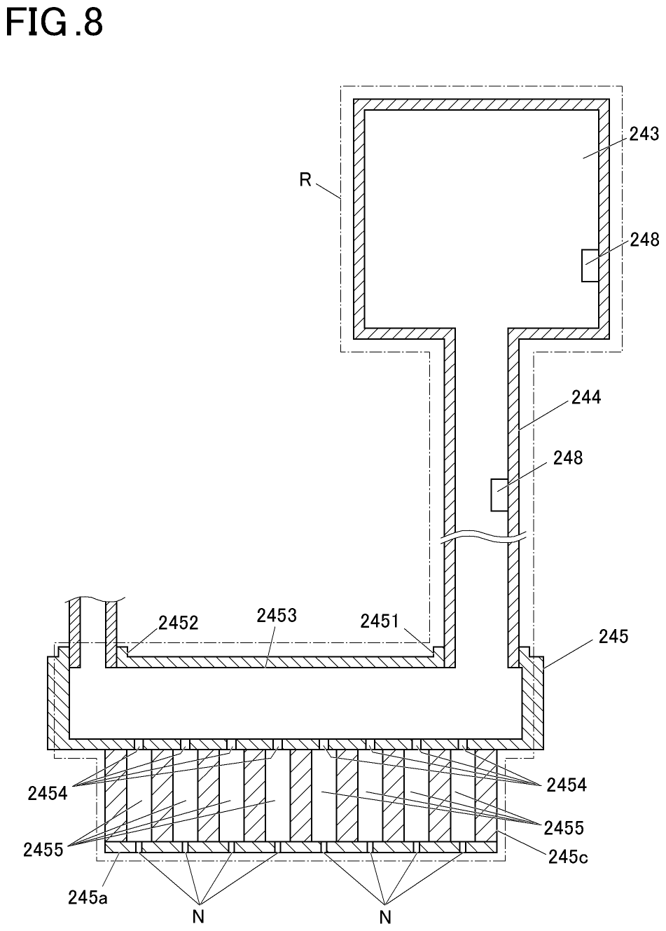

Ink flows into the inkjet head 245 from an inlet 2451, the ink is distributed to individual flow passages 2455 (refer to FIG. 8) corresponding to a plurality of nozzles through which ink is ejected, and ink that is not ejected flows out from an outlet 2452. The inlet 2451 is connected to the second sub-tank 243 through the second flow passage 244, and the outlet 2452 is connected to the first sub-tank 241 through the third flow passage 246.

The third flow passage 246 is provided with a circulation valve 2461. Ink circulation from the inkjet head 245 to the first sub-tank 241 is performed by opening the circulation valve 2461, and the ink circulation is stopped by closing the circulation valve 2461. In this manner, it is possible to discharge air bubbles or foreign matters which are mixed in the ink inside the inkjet head 245 from the inkjet head 245 by circulating the ink.

Any of the air open valves 2431 and 2432, and the circulation valve 2461 may be set as an electromagnetic valve of which an opening/closing operation is performed electromagnetically on the basis of control by the hardware processor 40.

An ink flow path relating to another head unit 24 is the same as in FIG. 7. However, one piece of the negative pressure generator 80 may be provided with respect to four pieces of the head units 24 and the one negative pressure generator 80 may be used commonly to the head units 24.

In addition, in the head units 24, the first sub-tank 241 and the second sub-tank 243 may be individually provided for every inkjet head 245, or ink may be supplied to two or more pieces of the head units 24 from one piece of the first sub-tank 241 and one piece of the second sub-tank 243.

FIG. 8 is a cross-sectional view of an ink flow passage in the second sub-tank 243, the second flow passage 244, and the inkjet head 245.

In FIG. 8, description of the first flow passage 242, and the air open valves 2431 and 2432 which are connected to the second sub-tank 243 is omitted. In addition, description of the ink heater 247 that is attached to the outer wall surfaces of the second sub-tank 243, the second flow passage 244, and the inkjet head 245 is omitted.

An ink flow passage inside the inkjet head 245 includes a common ink chamber 2543 that is connected to the inlet 2451 and the outlet 2452, and a head chip 245c that ejects ink from the nozzle N. The head chip 245c is provided with a plurality of the nozzles N, and individual flow passages 2455 which respectively communicate with the nozzles. The above-described piezoelectric element (not illustrated) is provided to be in contact with a wall surface of each of the individual flow passages 2455. An ink pressure inside the individual flow passage 2455 varies due to an operation of the piezoelectric element corresponding to a drive signal output from a head driver 249 (refer to FIG. 9), and a liquid droplet of the ink is ejected from an opening portion of the nozzle N in accordance with the variation.

Ink flowing from the inlet 2451 is supplied to the common ink chamber 2453. A through-hole 2454 that communicates with each of the individual flow passages 2455 of the head chip 245c is provided in a bottom surface of the common ink chamber 2453. Ink supplied to the common ink chamber 2453 is transmitted to the individual flow passage 2455 through the through-hole 2454, and is ejected from the nozzle N.

In the common ink chamber 2453, a filter that prevents foreign matters or air bubbles from being passed may be provided between the inlet 2451 side and the through-hole 2454 side.

In addition, an inner wall surface of the second sub-tank 243 and the second flow passage 244 is provided with a temperature detector 248 that detects a temperature of the inner wall surface (accordingly, a temperature of ink near the inner wall surface).

Hereinafter, in the configurations illustrated in FIG. 8, a continuous region that is filled with ink in the second sub-tank 243, the second flow passage 244, and the inkjet head 245 is described as an ink filled region R. The ink filled region R includes the second sub-tank 243, the second flow passage 244, and the common ink chamber 2453, the through-hole 2454, the individual flow passage 2455, and the nozzle N inside the inkjet head 245.

FIG. 9 is a block diagram illustrating a functional configuration of the inkjet recording device 1.

The inkjet recording device 1 includes the hardware processor 40, the recording medium heater 23, the head unit 24 including the head driver 249, the inkjet head 245, the liquid feeding pump 2421, the ink heater 247, and the temperature detector 248, the fixer 25, the intake pump 82, a conveyance driver 51, the head unit mover 52, an operation display 53, a communicator 54, the cleaner 62, a bus 55, and the like. Hereinafter, description of configurations which are described already will be omitted.

The hardware processor 40 is a hardware processor that collectively controls entire operations of the inkjet recording device 1. The hardware processor 40 includes a central processing unit (CPU) 41, a random access memory (RAM) 42, a read only memory (ROM) 43, a storage unit 44, and the like.

The CPU 41 reads out a program or setting data stored in the ROM 43 for various kinds of control, stores the program or the setting data in the RAM 42, and executes the program to perform various kinds of calculation processing.

The RAM 42 provides a memory space for work to the CPU 41, and temporarily stores data. The RAM 42 may include a non-volatile memory.

The ROM 43 stores the program for various kinds of control which is executed by the CPU 41, the setting data, and the like. A rewritable non-volatile memory such as a flash memory may be used instead of the ROM 43.

A print job (image recording command) input from an external device through the communicator 54, image data of a recording target image relating to the print job, and the like are stored in the storage unit 44. As the storage unit 44, for example, a hard disk driver (HDD) may be used, and a dynamic random access memory (DRAM) or the like may be used in combination.

The head driver 249 supplies a drive signal that deforms the piezoelectric element in correspondence with image data at appropriate timing with respect to a recording element of the inkjet head 245 to eject ink in an amount corresponding to a pixel value of the image data from the nozzle N of the inkjet head 245.

The ink heater 247 energizes a heater on the basis of a control signal supplied from the hardware processor 40 to heat ink in each portion of the ink flow passages in the head unit 24. In addition, the hardware processor 40 switches a heating operation performed by the ink heater 247 to maintain ink that is heated and becomes a sol phase at a predetermined reference temperature (80° C. in this embodiment). The switching of the heating operation may be plural-step switching in a step pattern even in a simple ON/OFF operation, or may be subjected to pulse width modulation (PWM) control by an ON/OFF operation at a high frequency.

The temperature detector 248 detects a temperature of ink on the inter wall surface of the second sub-tank 243 and the second flow passage 244 and outputs the temperature to the hardware processor 40.

The conveyance driver 51 supplies a drive signal to a conveying drum motor of the conveying drum 21 on the basis of a control signal supplied from the hardware processor 40 to rotate the conveying drum 21 at a predetermined speed and predetermined timing. In addition, the conveyance driver 51 supplies a drive signal to a motor for operating the medium feeder 12, the conveying unit 22, and the deliverer 26 on the basis of a control signal supplied from the hardware processor 40 to perform feeding of the recording medium M to the conveying drum 21 and ejection of the recording medium M from the conveying drum 21.

The head unit mover 52 outputs a drive signal to a motor or a brake of a movement mechanism that moves the head unit 24 in the width direction on the basis of a control signal supplied from the hardware processor 40, and moves the head unit 24 between the recording position, the wiping position, and the ink collection position.

The operation display 53 performs display of a status, an operation menu, and the like of the inkjet recording device 1 in correspondence with a control signal transmitted from the hardware processor 40, receives a user's operation, and outputs the operation to the hardware processor 40. For example, in the operation display 53, a touch sensor as an operation reception unit includes a liquid crystal display provided in a state of being superimposed on a display screen as a display unit.

The communicator 54 is a communication interface that control a communication operation with an external device. As the communication interface, for example, one or a plurality of interfaces such as a LAN board and a LAN card which correspond to various communication protocols are included. The communicator 54 acquires recording target image data or setting data (job data) relating to image recording from an external device on the basis of control by the hardware processor 40, and transmits status information or the like to the external device.

The bus 55 is a route that electrically connects the above-described constituent elements to perform signal exchange.

(Ink Heating Operation)

Next, an ink heating operation performed by the ink heater 247 in the head unit 24 will be described.

As described above, ink inside the head unit 24 is heated by the ink heater 247 and becomes a sol phase. A heating operation in a case in which gel-phase ink (hereinafter, also described to as “gel-phase ink InG) is heated to sol-phase ink (hereinafter, also described as “sol-phase ink InS) will be described in detail.

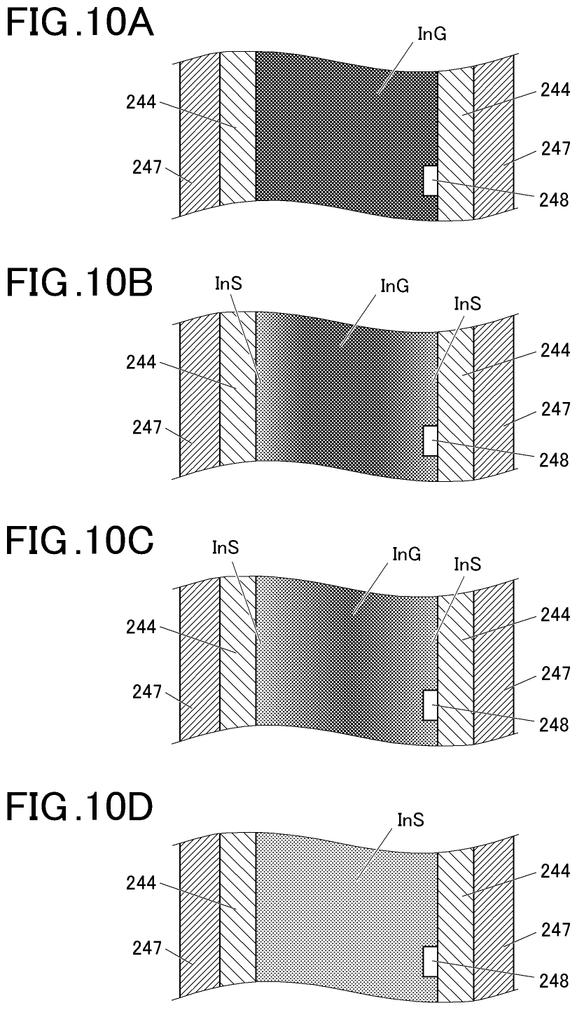

FIG. 10A to FIG. 10D are views illustrating a state in which the gel-phase ink InG is heated and becomes the sol-phase ink InS.

In FIG. 10A to FIG. 10D, a cross-section of a part of the second flow passage 244 is illustrated, but a heating operation in respective ink filled portions in the head unit 24 such as the second sub-tank and the inkjet head 245 is the same as in FIG. 10A to FIG. 10D. In addition, in FIG. 10A to FIG. 10D, the gel-phase ink InG is illustrated in a dark color, and the sol-phase ink InS is illustrated in a light color. The ink heater 247 is in contact with an outer wall surface of the second flow passage 244, and heat of the ink heater 247 is transferred to ink through the wall surface of the second flow passage 244. In this manner, the ink heater 247 heats an inner wall surface of each portion that includes the ink filled region R illustrated in FIG. 8 and is filled with ink to heat the ink.

FIG. 10A illustrates a state before heating performed by the ink heater 247, and the entirety of ink inside the second flow passage 244 is the gel-phase ink InG.

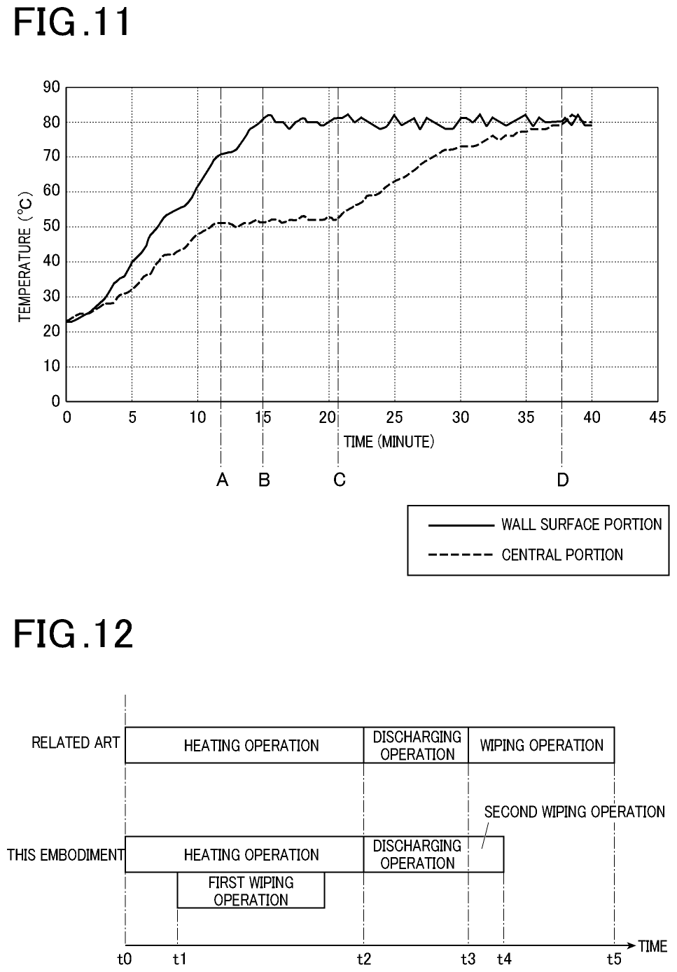

FIG. 11 is a view showing a temperature variation of ink near an inner wall surface and at the center in ink heating.

As shown in FIG. 11, an ink temperature at the time of initiating heating is not different between ink near the inner wall surface (hereinafter, simply described as ink on a wall surface) and ink at the center (ink near the center of a flow passage of the second flow passage 244), and is approximately 25° C.

When the ink is heated, the temperature of the ink on the wall surface is more rapidly raised in comparison to the temperature of the ink at the center. The reason for this is because heat is transferred first to the ink on the wall surface from the inner wall surface of the second flow passage 244.

In a period up to time B after reaching time A in FIG. 11, the temperature of the ink on the wall surface rises, and temperature rising of the ink at the center stagnates. The reason for this is because heat transferred from the ink heater 247 to the ink is used for phase transition of the ink on the wall surface. That is, the phase transition ink requires thermal energy when the phase transition from a gel phase to a sol phase, and thus phase transition of the ink on the wall surface to the sol phase occurs first, and heat is less likely transferred to the ink at the center. Accordingly, the ink at the center is maintained in a gel phase as is.

FIG. 10B illustrates an ink state in the period from the time A to the time B. In this period, phase transition of the ink on the wall surface to the sol-phase ink InS is initiated, and the ink at the center is maintained in the gel-phase ink InG as is.

At the time B in FIG. 11, the ink on the wall surface reaches 80° C. that is a reference temperature. Subsequently, the ink heater 247 performs a heating operation to maintain the temperature of the ink on the wall surface at 80° C. under control by the hardware processor 40. In a period from the time B to time C, the temperature of the ink on the wall surface is maintained at 80° C., and the ink at the center enters a state in which temperature rising stagnates. The reason for this is because liquefaction gradually progresses from the wall surface toward the center.

FIG. 10C illustrates an ink state in the period from the time A to the time B. As illustrated in the drawing, in the period, a region of the sol-phase ink InS gradually increases in comparison to the state in FIG. 10B.

In a period from the time C to time D in FIG. 11, heat is also transferred to the ink at the center, and the temperature of the ink at the center rises and liquefies. In addition, at the time D, as illustrated in FIG. 10D, the entirety of the ink becomes the sol-phase ink InS. Even after the time D, the ink heater 247 performs the heating operation to maintain the ink temperature at the reference temperature (80° C.) under control by the hardware processor 40.

(Maintenance Operation at Activation)

Next, description will be given of a maintenance operation in the inkjet recording device 1 of this embodiment, particularly, a maintenance operation in activation which is performed at the time of activating the inkjet recording device 1.

The maintenance operation in activation is performed in a case in which the inkjet recording device 1 is activated after an operation is stopped for a predetermined time or longer under an environment lower than a solation temperature. The predetermined time is time for which the ink in the head unit 24 is cooled down to the gel phase. In the maintenance operation in activation, a discharging operation of discharging the ink from the nozzle N, and a wiping operation of wiping the nozzle opening surface 245a of the inkjet head 245 with the cleaner 62 to clean the nozzle opening surface 245a. In the operations, the discharging operation is one aspect of an ejection operation of ejecting the ink from the nozzle N. In addition, control in which the hardware processor 40 causes the inkjet head 245 to perform the discharging operation corresponds to “ejection control”, and control in which the hardware processor 40 causes the cleaner 62 to perform the wiping operation corresponds to “wiping control”.

When the discharging operation is performed, it is possible to discharge air or foreign matters mixed in the inside of the individual flow passages 2455 or the nozzle N to the outside from the nozzle N. The discharging operation is performed in a state in which the head unit 24 is moved to the ink collection position, and the ink discharged from the nozzle N is collected in the ink collector 61. In addition, the discharging operation is performed in a state in which ink at least in the ink filled region R in the ink inside the head unit 24 is heated and the entirety of the ink becomes a sol phase.

The discharging operation is performed by operating the liquid feeding pump 2421 in a state in which the air open valves 2431 and 2432 are closed. According to this, ink pressurized by a liquid feeding operation of the liquid feeding pump 2421 is supplied to the nozzle N of the inkjet head 245, and ink is compulsorily discharged (ejected) from the nozzle N in correspondence with an ink pressure. The discharging is also referred to as pressurization purge. The discharging operation may be performed by ink ejection corresponding to a pressure variation by a piezoelectric element as in typical image recording.

The wiping operation is an operation of wiping the nozzle opening surface 245a by the wiping fabric 621 of the cleaner 62. When the wiping operation is performed, it is possible to remove foreign matters or ink adhered to the nozzle opening surface 245a.

In addition, when performing the discharging operation, there is a concern that a part of ink that is discharged or ink mist that occurs during the ink discharging may adhere to the nozzle opening surface 245a. Accordingly, the wiping operation is performed at least after completion of the discharging operation to wipe out the ink adhered to the nozzle opening surface 245a due to the discharging operation. The wiping operation aimed to wipe out the adhered ink by the discharging operation can be performed at a higher speed (accordingly, within a short time) in comparison to the wiping operation aimed to remove foreign matters or solidified ink adhered to the nozzle opening surface 245a.

Typically, the inkjet recording device 1 is installed in an environment that is equal to or lower than gelation temperature of ink, and thus at the time of the above-described activation, ink in the head unit 24 includes ink in the ink filled region R, and the entirety of the ink is in a gel phase. Accordingly, in the maintenance operation in activation, first, a heating operation of heating ink in the ink filled region by the ink heater 247 to change the phase of ink from a gel phase to a sol phase is performed to enable the discharging operation to be executed. The heating operation of this embodiment is performed in a state in which the inside of the second sub-tank 243 is set to a negative pressure by the negative pressure generator 80. Control in which the hardware processor 40 causes the negative pressure generator 80 to generate the negative pressure in the second sub-tank 243, and ink is heated by the ink heater 247 corresponds to “heating control”.

FIG. 12 is a view illustrating an execution procedure and execution timing of each operation in the maintenance operation in activation in the related art and in the maintenance operation in activation in this embodiment.

In the maintenance operation in activation in the related art, the heating operation is initiated at timing t0. and at timing t2 at which the heating operation is terminated (that is, after the entirety of the ink in the head unit 24 including the ink filled region R becomes a sol phase), the discharging operation is initiated. In addition, at timing t3 at which the discharging operation is terminated, the wiping operation is initiated, and at timing t5 at which the wiping operation is terminated, the maintenance operation in activation is terminated.

In contrast, in the maintenance operation in activation in this embodiment, a wiping operation for the first time (first wiping operation) is initiated at timing t1 at which a negative pressure acts on the ink in the nozzle N to be described later after the heating operation is initiated. The first wiping operation is performed for the purpose of rubbing and wiping foreign matter or solidified ink adhered to the nozzle opening surface 245a by rubbing the foreign matters, and thus the first wiping operation is performed for the same time as in the wiping operation in the related art.

In addition, the discharging operation is initiated at the timing t2 at which the heating operation is terminated, a wiping operation for the second time (second wiping operation) is initiated at the timing t3 at which the discharging operation is terminated. The second wiping operation is performed for the purpose of absorbing and removing liquid ink adhered to the nozzle opening surface 245a due to the discharging operation, and thus the second wiping operation is performed at a higher speed and is terminated within an extremely shorter time in comparison to the first wiping operation. That is, the second wiping operation is initiated at the timing t3 as in the wiping operation in the related art, but the second wiping operation is terminated at timing t4 before the timing t5 at which the wiping operation in the related art is terminated. Accordingly, the maintenance operation in activation in this embodiment is terminated in a shorter time in comparison to the maintenance operation in activation in the related art.

As described above, in the maintenance operation in activation in this embodiment, the first wiping operation is performed in combination with a part of the heating operation, and thus time of the entirety of the maintenance operation in activation is shortened.

Hereinafter, description will be given of the reason why the heating operation and the first wiping operation can be performed in combination.

The heating operation of this embodiment is performed in a state in which the inside of the second sub-tank 243 is set to a negative pressure by opening the air open valve 2432. In a case in which the heating operation is initiated, ink in the inkjet head 245 an ink flow passage is fine, particularly, ink in the head chip 245c in which a diameter of the flow passage is set to several tens of μm is heated at the earliest, and becomes a sol phase. The reason for this is because ink in the fine flow passage is close to the inner wall surface that is heated and thus heat is likely to be transferred to the ink.

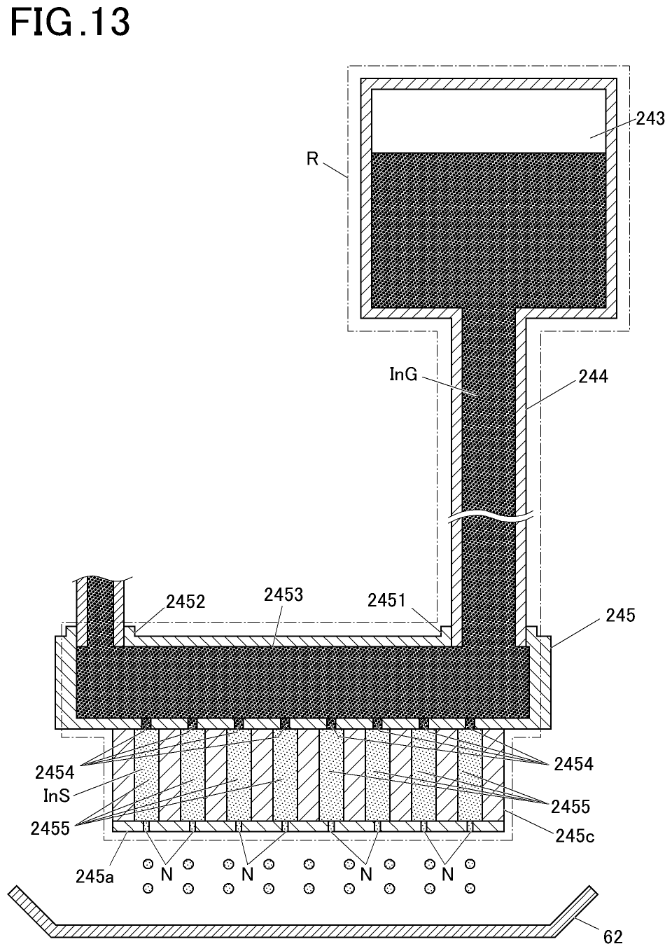

FIG. 13 is a cross-sectional view of the ink flow passage in the second sub-tank 243, the second flow passage 244, and the inkjet head 245 in a state in which the ink in the head chip 245c becomes the sol phase.

In the state in FIG. 13, ink in the head chip 245c of the inkjet head 245 (that is, ink in the individual flow passages 2455 and the nozzle N) is heated and becomes the sol-phase ink InS. On the other hand, ink in the second sub-tank 243, the second flow passage 244, and the common ink chamber 2453 of the inkjet head 245 remains as the gel-phase ink InG.

In the state in FIG. 13, the negative pressure in the second sub-tank 243 does not act on the ink in the nozzle N. The reason for this is because the gel-phase ink InG in the second sub-tank 243 or the second flow passage 244 does not transfer the negative pressure in the second sub-tank 243. Accordingly, the sol-phase ink InS in the nozzle N is not inserted to an inner side due to the negative pressure, and is leaked from the nozzle N. Accordingly, the heating operation is performed in a state in which the head unit 24 is moved to the ink collection position to collect the ink leaked from the nozzle N. Accordingly, as illustrated in FIG. 13, the ink that is leaked from the nozzle N and drops is collected by the ink collector 61.

In a case in which the ink is further heated from the state in FIG. 13, in respective parts of the ink filled region R, the phase change of ink on a wall surface into the sol-phase ink InS occurs.

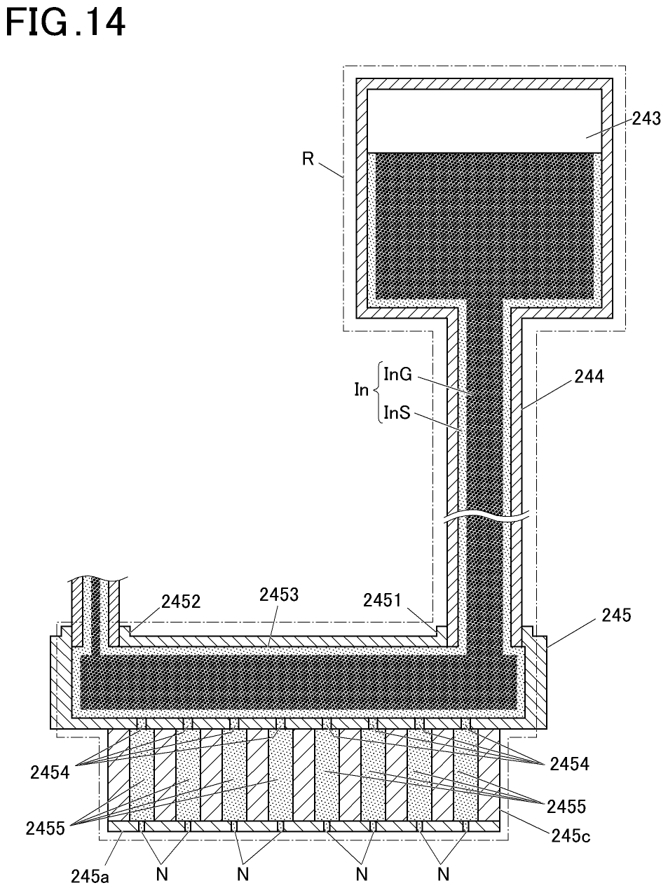

FIG. 14 is a view illustrating a state in which the ink on the wall surface in the respective parts of the ink filled region R becomes the sol-phase ink InS.

In this state, the negative pressure in the second sub-tank 243 acts on the ink in the nozzle N through the sol-phase ink InS on the wall surface. Accordingly, the ink in the nozzle N is inserted to an inner side due to the negative pressure, and leakage of the ink from the nozzle N is stopped. According to this, it is possible to move the head unit 24 from the ink collection position to the wiping position, and it is possible to initiate the wiping operation (the above-described first wiping operation) by the cleaner 62. It is possible to determine a situation in which the ink on the wall surface of the respective parts in the ink filled region R becomes the sol-phase ink InS on the basis of a situation in which a detection temperature by the temperature detector 248 has reached a reference temperature.

After the first wiping operation is initiated, as illustrated in FIG. 12, the first wiping operation and the heating operation are performed in combination, and then the entirety of the ink in the ink filled region R becomes the sol-phase ink InS due to the heating operation.

(Control Sequence of Maintenance Processing in Activation)

Next, a control sequence by the hardware processor 40 in the maintenance processing in activation will be described.

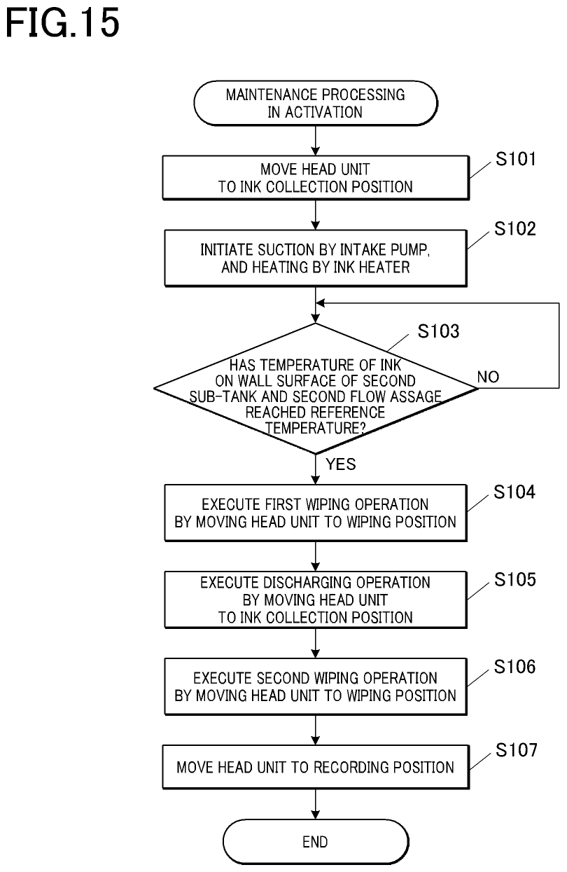

FIG. 15 is a flowchart illustrating a control sequence of the maintenance processing in activation.

In a case in which the maintenance processing in activation is initiated, the hardware processor 40 starts to transmit a control signal to the head unit mover 52, and moves the head unit 24 to the ink collection position (step S101).

The hardware processor 40 initiates suction by the intake pump 82, and initiates ink heating by the ink heater 247 (step S102).

The hardware processor 40 determines whether or not a temperature of ink on a wall surface in the second sub-tank 243 and the second flow passage 244 has reached the reference temperature on the basis of a detection signal transmitted from the temperature detector 248 (step S103). In a case in which it is determined that the temperature of the ink on the wall surface has not reached the reference temperature (“NO” in step S103), the hardware processor 40 executes the processing in step S103 again.

In a case in which it is determined that the temperature of the ink on the wall surface has reached the reference temperature (“YES” in step S103), the hardware processor 40 causes the head unit mover 52 to move the head unit 24 to the wiping position, and causes the cleaner 62 to execute the first wiping operation (step S104).

In the determination, it is determined that the negative pressure has acted on the ink in the nozzle N when the ink temperature has reached the reference temperature, but another temperature higher than the liquefaction temperature may be used for the determination instead of the reference temperature. In addition, initiation timing of the first wiping operation may be set to timing after a predetermined delay time has elapsed with respect to the timing at which the ink temperature has reached the reference temperature.

After the entirety of the ink in the ink filled region R becomes the sol phase, the hardware processor 40 performs the ejection control of causing the head unit mover 52 to move the head unit 24 to the ink collection position, and causing the head unit 24 to perform the discharging operation (step S105). The hardware processor 40 causes the discharging operation to be performed by operating the liquid feeding pump 2421 in a state in which the air open valves 2431 and 2432 are closed.

For example, the processing in step S105 is initiated at the following timing. That is, time taken until the entirety of the ink in the ink filled region R becomes the sol phase is acquired in advance, and the processing in step S105 is initiated at timing after the time has elapsed from ink heating initiation. Alternatively, a temperature detector may be provided at a position at which the ink in the ink filled region R finally solates (typically, the central portion of the second sub-tank 243 which is the longest from the inner wall surface), and the processing in step S105 may be caused to start at timing at which the detection temperature by the temperature detector becomes equal to or higher than the reference temperature.

In a case in which the discharging operation is terminated, the hardware processor 40 causes the head unit mover 52 to move the head unit 24 to the wiping position, and causes the cleaner 62 to execute the second wiping operation at a higher speed in comparison to the first wiping operation (step S106).

When the second wiping operation is terminated, the hardware processor 40 causes the head unit mover 52 to move the head unit 24 to the recording position (step S107).

In a case in which the processing in step S107 is terminated, the hardware processor 40 terminates the maintenance processing in activation. Subsequently, in a case in which print job is input through the communicator 54, recording processing of recording an image with respect to the recording medium M is initiated.

As described above, the inkjet recording device 1 according to this embodiment includes the inkjet head 245 including the nozzle N from which ink of which a phase is changed between a gel phase as one aspect of a solid and a sol phase as one aspect of a liquid is ejected, the second sub-tank 243 that stores the ink, the second flow passage 244 which is connected to the second sub-tank 243 and the inkjet head 245 and through which the ink to be supplied from the second sub-tank 243 to the inkjet head 245 passes, the negative pressure generator 80 that generates a negative pressure in the second sub-tank 243, the ink heater 247 that heats ink in the ink filled region R in the second sub-tank 243, the second flow passage 244, and the inkjet head 245, the cleaner 62 that performs the wiping operation of wiping the nozzle opening surface 245a of the inkjet head 245 in which the opening portion of the nozzle N is formed with the wiping fabric 621, and the hardware processor 40. In a case in which the ink in the ink filled region R is a solid, the hardware processor 40 performs the heating control including the control of causing the negative pressure generator 80 to generate a negative pressure in the second sub-tank 243, and the control of causing the ink heater 247 to heat the ink in the ink filled region R in a state in which the negative pressure is generated to change the phase of the ink from the gel phase to the sol phase. In a case in which the negative pressure in the second sub-tank 243 acts on the ink in the nozzle N by the heating control, the hardware processor initiates the wiping control of causing the cleaner 62 to perform the first wiping operation and performs the wiping control in combination with the heating control.

As described above, when the ink is heated while generating the negative pressure in the second sub-tank 243, it is possible to allow the negative pressure to act on the ink in the nozzle N at the point of time at which a region from the second sub-tank 243 to the nozzle N is connected by the sol-phase ink, and thus it is possible to prevent ink leakage from the nozzle N. Accordingly, it is possible to initiate the first wiping operation in the middle of the ink heating operation. The phase transition ink requires thermal energy when the phase transition from a gel phase to a sol phase, and thus a long time is required to heat the ink in the ink filled region R for phase transition of the entirety of the ink to the sol phase. However, since the heating operation and the first wiping operation can be performed in combination, a heating operation time can be effectively used. As a result, it is possible to further shorten a maintenance operation time in activation in comparison to the related art in which the discharging operation and the wiping operation are performed after the phase transition of the entirety of ink to the sol phase. Accordingly, it is possible to shorten stand-by time until image formation becomes possible after termination of the maintenance operation in activation.

In addition, the ink heater 247 heats the ink in the ink filled region R by heating the inner wall surface of the ink filled region R to a predetermined temperature higher than the liquefaction temperature at which the phase of the ink is changed from the gel phase to the sol phase, and in a case in which the negative pressure acts on the ink in the nozzle N through a portion that is heated in the vicinity of the inner wall surface and becomes the sol phase in the ink inside the ink filled region, the hardware processor 40 initiates the wiping control. According to this, the ink near the inner wall surface is set to the sol phase with a simple configuration of heating the second sub-tank 243, the second flow passage 244, and the inkjet head 245 which constitute the ink filled region R from the outer wall surface, and thus it is possible to allow the negative pressure to act on the ink in the nozzle N through the sol-phase portion.

In addition, the hardware processor 40 determines initiation timing of the wiping operation on the basis of a temperature of the inner wall surface of the ink filled region R. According to this, it is possible to determine a situation in which the negative pressure acts on the ink in the nozzle N and thus the wiping operation can be initiated with a simple method.

In addition, the predetermined temperature is set to be equal to or higher than the ink liquefaction temperature by +5° C. or higher and is equal to or lower than the ink liquefaction temperature by +15° C. or less, and thus it is possible to suppress occurrence of a problem in which the ink is heated to a temperature higher than necessary, and power consumption increases.

In addition, the inkjet recording device 1 includes the ink collector 61 that accommodates ink that becomes the sol phase in the nozzle N after initiation of the heating control and is leaked from the nozzle N. Since the negative pressure does not act on the ink that becomes the sol phase in the nozzle N after initiation of the heating operation, ink is leaked from the nozzle N and drops, but when the ink collector 61 is provided, it is possible to collect the dropped ink. In addition, even in the configuration provided with the ink collector 61, at a step in which the negative pressure acts on the ink in the nozzle N and ink leakage is stopped, it is possible to move the head unit 24 from the ink collection position facing the ink collector 61 to the wiping position, and thus it is possible to initiate the first wiping operation in the middle of the ink heating operation.

In addition, the inkjet recording device 1 includes the head unit 24 including the inkjet head 245, the second flow passage 244, and the second sub-tank 243, and the head unit mover 52 that moves the head unit 24 between the ink collection position at which the nozzle opening surface 245a faces the ink collector 61, and the wiping position at which the cleaner 62 can execute the wiping operation. At this time, in a step in which the negative pressure acts on the ink in the nozzle N and ink leakage from the nozzle N is stopped, it is possible to initiate the first wiping operation by effectively moving the head unit 24 to the wiping position. In addition, in a case in which the head unit 24 includes a plurality of the inkjet heads 245 at positions different from each other in the movement direction set by the head unit mover 52 (that is, the head unit 24 constitutes a line head), a movement distance of the head unit 24 between the ink collection position and the wiping position increases. However, since the head unit 24 can be moved in the middle of the heating operation it is possible to suppress the maintenance operation in activation is lengthened due to the movement.

In addition, the hardware processor 40 initiates the heating control in a state in which the head unit 24 is located at the ink collection position, and initiates the wiping control after causing the head unit mover 52 to move the head unit 24 to the wiping position. According to this, it is possible to quickly initiate the first wiping operation at a step in which ink leakage from the nozzle N is stopped while collecting the ink leaked from the nozzle N immediately after initiation of the heating operation with the ink collector 61.

In addition, in a case in which the inkjet recording device 1 is activated after an operation is stopped for a predetermined time or longer under an environment lower than a solation temperature, the hardware processor 40 performs the heating control and the wiping control. In this case, the ink inside the head unit 24 including the ink filled region R becomes the gel phase. However, when performing the heating control and the wiping control having the above-described characteristics, it is possible to effectively perform the maintenance operation in activation, and it is possible to shorten standby time until image recording becomes possible.

In addition, in a case in which the entirety of the ink in the ink filled region R becomes the sol phase due to the heating control, the hardware processor 40 performs the ejection control of discharging (ejecting) the ink from the nozzle N of the inkjet head 245. In a case in which the phase change ink is heated for phase transition from the gel phase to the sol phase, the volume shrinks due to an increase of viscosity. Due to the volume shrinkage of the ink, air may be mixed-in to the inside of the nozzle N from the opening portion of the nozzle N. In contrast, when the discharging operation is performed after the ink becomes the sol phase as described above, it is possible to discharge the mixed-in air to the outside from the nozzle N in combination with the ink.

In addition, the hardware processor 40 performs the ejection control after termination of the first wiping operation. In this manner, when the time-consuming first wiping operation is performed in combination with the heating operation before initiation of the discharging operation (that is, before the entirety of the ink becomes the sol phase), it is possible to shorten time in the maintenance operation in activation.

In addition, the hardware processor 40 causes the cleaner 62 to wipe the ink adhered to the nozzle opening surface 245a after termination of the ejection control at a higher speed in comparison to the wiping operation that is caused to be performed by the cleaner 62 in the wiping control. At an initiation point of time of the second wiping operation, since ink or foreign matters solidified on the nozzle opening surface 245a are removed in advance by the first wiping operation, in the second wiping operation, it is sufficient that the liquid ink adhered to the nozzle opening surface 245a due to the discharging operation is absorbed and removed. Accordingly, the second wiping operation can be performed at a higher speed in comparison to the first wiping operation, and can be completed within a short time. Accordingly, when sequentially performing the respective operations in the order of the first wiping operation, the discharging operation, and the second wiping operation, it is possible to shorten time of the second wiping operation after the discharging operation, and as a result, it is possible to shorten time of the maintenance operation in activation.

In addition, in the maintenance method of this embodiment, in a case in which the ink in the ink filled region R is a gel phase, the negative pressure is generated in the second sub-tank 243 by the negative pressure generator 80, and in a state in which the negative pressure is generated, the ink in the ink filled region R is heated by the ink heater 247, and the phase of the ink is changed from the gel phase to the sol phase. In a case in which the negative pressure in the second sub-tank 243 acts on the ink in the nozzle N, the wiping operation by the cleaner 62 is caused to start, and the wiping operation is caused to be performed while changing the phase of the ink from the gel phase to the sol phase. According to this method, it is possible to shorten time of the maintenance operation in activation. Accordingly, it is possible to shorten standby time until image formation becomes possible after termination of the maintenance operation in activation.

The invention is not limited to the embodiment and respective modification examples, and various changes can be made.

For example, in the embodiment, description has been given with reference to an example in which the inner wall surface of the ink filled region R is heated for phase change to the sol phase from ink on the wall surface, but there is no limitation thereto. For example, a tubular heater may be inserted into the ink filled region R, and phase transition to the sol phase may be caused to occur from ink near the heater. Even in this configuration, at a step in which a range from the second sub-tank 243 to the nozzle N is connected by the sol-phase ink, it is possible to cause the negative pressure in the second sub-tank 243 to act on the nozzle N.

The configuration of the cleaner 62 is not limited to the configuration illustrated in FIG. 5, and may be a configuration in which a blade-shaped wiping member is moved while coming into contact with the nozzle opening surface 245a.

In addition, in the embodiment, description has been given with reference to an example in which the temperature detector 248 is provided on the inner wall surface of the second sub-tank 243 and the second flow passage 244, but there is no limitation thereto. The temperature detector 248 may be provided on an outer wall surface of the second sub-tank 243 and the second flow passage 244, or the like. In addition, the temperature detector 248 may be provided in the inkjet head 245.

In addition, in the embodiment, description has been given with reference to a configuration in which the ink in the inkjet head 245 is circulated to the first sub-tank 241 through the third flow passage 246, but there is no limitation thereto. In a case in which ink circulation is not performed, the third flow passage 246 may be omitted.

In addition, in the embodiment, description has been given with reference to an example in which the recording medium M is conveyed by the conveying drum 21, but there is no limitation thereto. For example, the invention is applicable to an inkjet recording device in which the recording medium M is conveyed by a conveyance belt that is supported by two rollers and is moved in correspondence with rotation of the rollers.

In addition, in the embodiment, description has been given with reference to the inkjet recording device 1 of the single pass type, but the invention is applicable to an inkjet recording device that performs image recording while performing scanning with the recording head.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet recording device comprising:
an inkjet lead that includes a nozzle from which ink of which a phase is changed between a solid and a liquid is ejected;
an ink storage that stores the ink;
a flow passage which is connected to the ink storage and the inkjet head and through which the ink to be supplied from the ink storage to the inkjet head passes;
a negative pressure generator that generates a negative pressure in the ink storage;
a heater that heats ink in an ink filled region in the ink storage, the flow passage, and the inkjet head;
a wiper that performs a wiping operation of wiping a nozzle opening surface of the inkjet head in which an opening portion of the nozzle is formed with a wiping member; and
a hardware processor,
wherein in a case in which the ink inside the ink filled region is a solid, the hardware processor performs heating control including control of causing the negative pressure generator to generate a negative pressure in the ink storage, and control of causing the heater to heat ink in the ink filled region in a state in which the negative pressure is generated to change the phase of the ink from a solid to a liquid, and
in a case in which the negative pressure in the ink storage acts on the ink in the nozzle by the heating control, the hardware processor initiates wiping control of causing the wiper to perform the wiping operation and performs the wiping control in combination with the heating control.

2. The inkjet recording device according to claim 1,
wherein the heater heats the ink in the ink filled region by heating an inner wall surface of the ink filled region to a predetermined temperature higher than a liquefaction temperature at which the phase of the ink is changed from a solid to a liquid, and
in a case in which the negative pressure acts on the ink in the nozzle through a portion that is heated in the vicinity of the inner wall surface and becomes a liquid in the ink inside the ink filled region, the hardware processor initiates the wiping control.

3. The inkjet recording device according to claim 2,
wherein the hardware processor determines initiation timing of the wiping operation on the basis of a temperature of the inner wall surface of the ink filled region.

4. The inkjet recording device according to claim 2,
wherein the predetermined temperature is equal to or higher than the ink liquefaction temperature by +5° C. or higher and is equal to or lower than the ink liquefaction temperature by +15° C. or less.

5. The inkjet recording device according to claim 1, further comprising:
an ink collector that accommodates ink that becomes a liquid in the nozzle after initiation of the heating control and is leaked from the nozzle.

6. The inkjet recording device according to claim 5, further comprising:
a head unit that includes the inkjet head, the flow passage, and the ink storage; and
a head unit mover that moves the head unit between a first position at which the nozzle opening surface faces the ink collector, and a second position at which the wiper is capable of executing the wiping operation.

7. The inkjet recording device according to claim 6,
wherein the hardware processor initiates the heating control in a state in which the head unit is located at the first position, and initiates the wiping control after causing the head unit mover to move the head unit to the second position.

8. The inkjet recording device according to claim 1,
wherein in a case in which the inkjet recording device is activated after an operation is stopped for a predetermined time or longer under an environment lower than a phase transition temperature of the ink from a liquid to a solid, the hardware processor performs the heating control and the wiping control.

9. The inkjet recording device according to claim 1,
wherein in a case in which the entirety of the ink in the ink filled region becomes a liquid by the heating control, the hardware processor performs ejection control of ejecting the ink from the nozzle of the inkjet head.

10. The inkjet recording device according to claim 9,
wherein the hardware processor performs the ejection control after termination of the wiping operation.

11. A maintenance method of an inkjet recording device including an inkjet lead that includes a nozzle from which ink of which a phase is changed between a solid and a liquid is ejected, an ink storage that stores the ink, a flow passage which is connected to the ink storage and the inkjet head and through which the ink to be supplied from the ink storage to the inkjet head passes, a negative pressure generator that generates a negative pressure in the ink storage, a heater that heats ink in an ink filled region in the ink storage, the flow passage, and the inkjet head, and a wiper that performs a wiping operation of wiping a nozzle opening surface of the inkjet head in which an opening portion of the nozzle is formed with a wiping member, the maintenance method comprising:
generating a negative pressure in the ink storage by the negative pressure generator, and changing the phase of the ink from a solid to a liquid by heating the ink in the ink filled region by the heater in a state in which the negative pressure is generated in a case in which the ink inside the ink filled region is a solid;
initiating the wiping operation by the wiper in a case in which the negative pressure in the ink storage acts on the ink in the nozzle; and
causing the wiping operation to be performed while changing the phase of the ink from a solid to a liquid.
